(19) United States
(12) Patent Application Publication
(10) Pub. No.: US 2009/0173332 A1
(43) Pub. Date: Jul. 9, 2009

(54) CONVERTIBLE COOKING GRATE ASSEMBLY WITH DUAL COOKING SURFACES

(76) Inventor: Chris Lott, Minneapolis, KS (US)

Correspondence Address: THOMPSON & THOMPSON, P.A., P.O BOX 166, SCANDIA, KS, 66966, US

(21) Appl. No.: 12/348,011

(22) Filed: Jan. 1, 2009

Related U.S. Application Data
(60) Provisional application No. 61/019,394, filed on Jan. 7, 2008.

(51) Int. Cl. F23H 17/00; A47J 37/07

(52) U.S. Cl. 126/153; 99/450

(57) ABSTRACT

A convertible cooking grate provides dual cooking surfaces for use with barbecue grills. In a first position, a grate-like cooking surface is formed by a plurality of spaced apart bars that support an item being cooked above the heat source. In a second position, a substantially flat griddle-like cooking surface is formed by a plurality of bars having substantially coplanar surfaces that fit closely together. The bars are rotatably supported by pins that extend from each end thereof and fit into corresponding holes in an outer frame. A mechanical linkage is provided to rotate the bars together simultaneously between the first and second positions.

### RELATED APPLICATIONS

This application claims priority of U.S. Provisional Application No. 61/019,394 filed on Jan. 7, 2008. The content of this prior application is incorporated herein by reference.

### BACKGROUND OF THE INVENTION

1. Field of the Invention

This invention relates generally to cooking surfaces for grills, and in particular, to a convertible cooking grate that provides both a grate-like cooking surface and a griddle-like cooking surface.

2. Description of the Related Art

There are currently various types of cooking grids for use with barbecue grills. For example, in U.S. Pat. No. 5,467,691 issued to Koziol, a dual purpose cooking grid is disclosed having a first side for cooking large pieces of food and a second side for cooking small pieces of food. In Koziol's device, the entire grid is inverted to change the cooking surface, and neither side provides a griddle-like cooking surface. Similarly, in U.S. Pat. No. 6,481,343 issued to Rigney et al., a barbecue grill grate is provided that can be reversed to change between a grate surface with widely spaced surfaces, and a grate surface with a combination of flat surfaces and apertures.

In U.S. Pat. No. 6,945,160 issued to Christensen et al., an outdoor cooker and smoker apparatus is provided in which a plurality of louvers are provided between the heat source and the cooking surface. The louvers are movable between a first open position for direct heat cooking, and a second closed position for indirect heat cooking. The louvers in Christensen et al. are not used as a cooking surface.

There is a need for an improved cooking grate assembly that provides both a grate-like cooking surface and a griddle-like cooking surface.

### SUMMARY OF THE INVENTION

A convertible cooking grate assembly according to the present invention provides dual cooking surfaces for use with barbecue grills. In a first position, a grate-like cooking surface is formed by a plurality of spaced apart cross bars that support an item being cooked above the heat source. In a second position, a substantially flat griddle-like cooking surface is formed by a plurality of bars having substantially coplanar surfaces that fit closely together. The bars are rotatably supported by pins that extend from each end thereof and fit into corresponding holes in an outer frame. A mechanical linkage is provided to rotate the bars together simultaneously between the first and second positions.

According to a broad aspect of the present invention, a convertible cooking grate assembly for a grill is provided, comprising: a plurality of substantially similar elongate bars arranged in parallel relation to each other, each bar having a first portion for forming a first cooking surface and a second portion for forming a second cooking surface. The bars are each supported for rotation about respective horizontal axes for movement between a first position in which the first portions of the bars face upwardly to form the first cooking surface, and a second position in which the second portions of the bars face upwardly to form the second cooking surface.

Numerous other objects of the present invention will be apparent to those skilled in this art from the following description wherein there is shown and described an embodiment of the present invention, simply by way of illustration of one of the modes best suited to carry out the invention. As will be realized, the invention is capable of other different embodiments, and its several details are capable of modification in various obvious aspects without departing from the invention. Accordingly, the drawings and description should be regarded as illustrative in nature and not restrictive.

### BRIEF DESCRIPTION OF THE DRAWINGS

The present invention will become more clearly appreciated as the disclosure of the present invention is made with reference to the accompanying drawings. In the drawings:

FIG. 1 is a perspective view of a convertible cooking grate unit according to the present invention, with a plurality of cross bars moved to their first positions to form a grate-like cooking surface.

FIG. 2 is another perspective view of the cooking grate unit shown in FIG. 1.

FIG. 3 is an elevation view of the cooking grate unit shown in FIG. 1, with the cross bars in their first positions to form a grate-like cooking surface.

FIG. 4 is a plan view of the cooking grate unit shown in FIG. 1, with the cross bars in their first positions to form a grate-like cooking surface.

FIG. 5 is another elevation view of the cooking grate unit shown in FIG. 1, with the cross bars in their first positions to form a grate-like cooking surface.

FIG. 6 is an elevation view of one of the cross bars used in the cooking grate unit, which is movable between a first position (shown in solid lines) and a second position (shown in dashed lines).

FIG. 7 is an elevation view of the cooking grate unit, with the outer frame removed and the cross bars in their first positions to form a grate-like cooking surface.

FIG. 8 is an elevation view of the cooking grate unit similar to FIG. 7, with the cross bars in their second positions to form a griddle-like cooking surface.

FIG. 9 is an elevation view of the cooking grate unit, with the outer frame in place and the cross bars in their second positions to form a griddle-like cooking surface.

FIG. 10 is a perspective view of the cooking grate unit, with the cross bars in their second positions to form a griddle-like cooking surface.

FIG. 11 is a detail perspective view of the cooking grate unit, with the cross bars in their second positions to form a griddle-like cooking surface.

FIG. 12 is a detail elevation view of the cooking grate unit, with the cross bars in their second positions to form a griddle-like cooking surface.

FIG. 13 is another detail elevation view of the cooking grate unit, showing the cross bars movable between their second positions (shown in solid lines) and their first positions (shown in dashed lines).

### DETAILED DESCRIPTION OF THE INVENTION

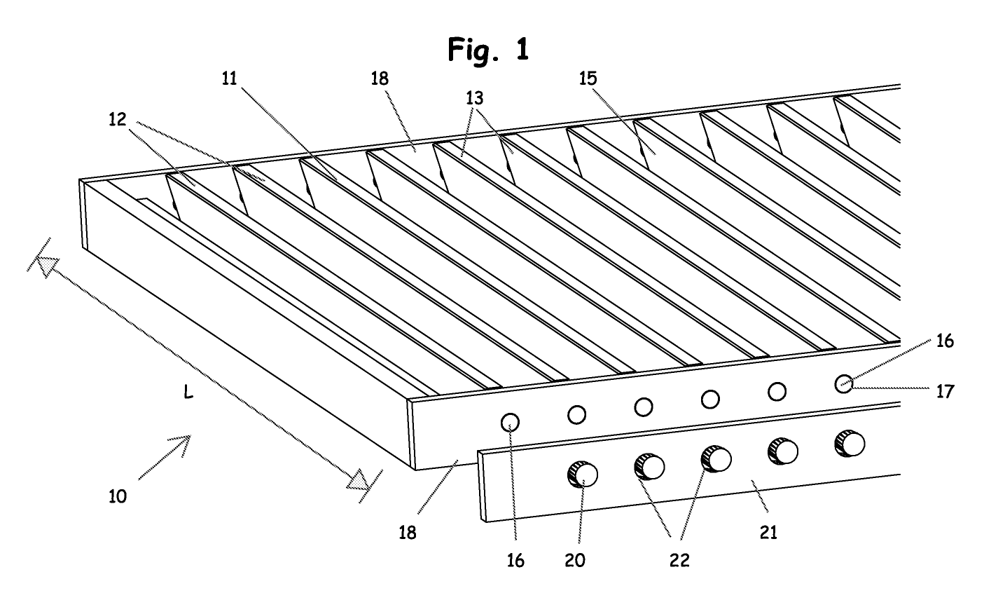

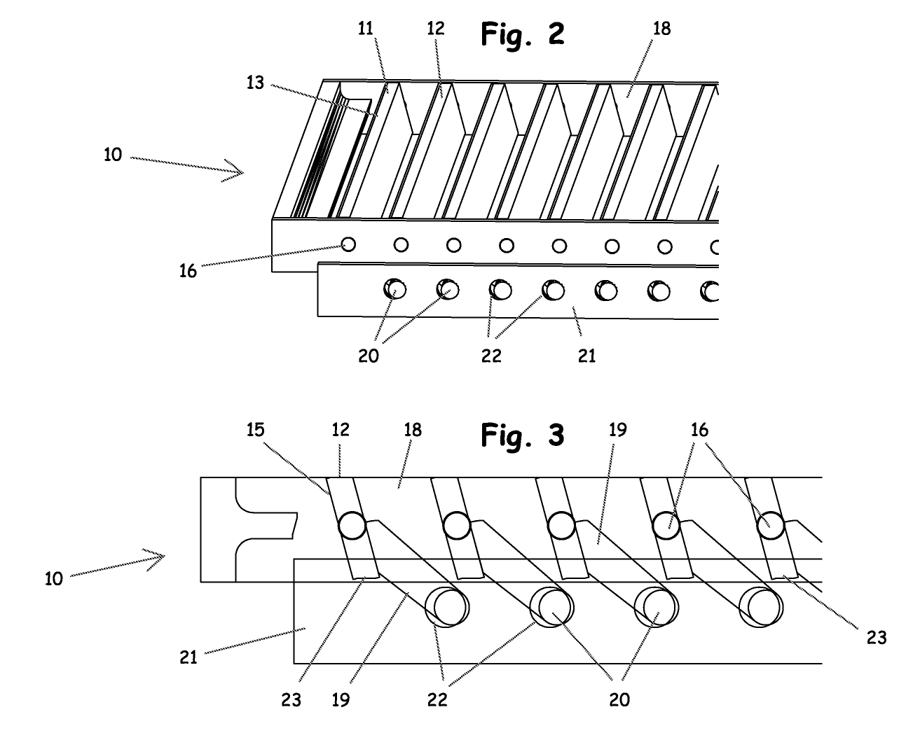

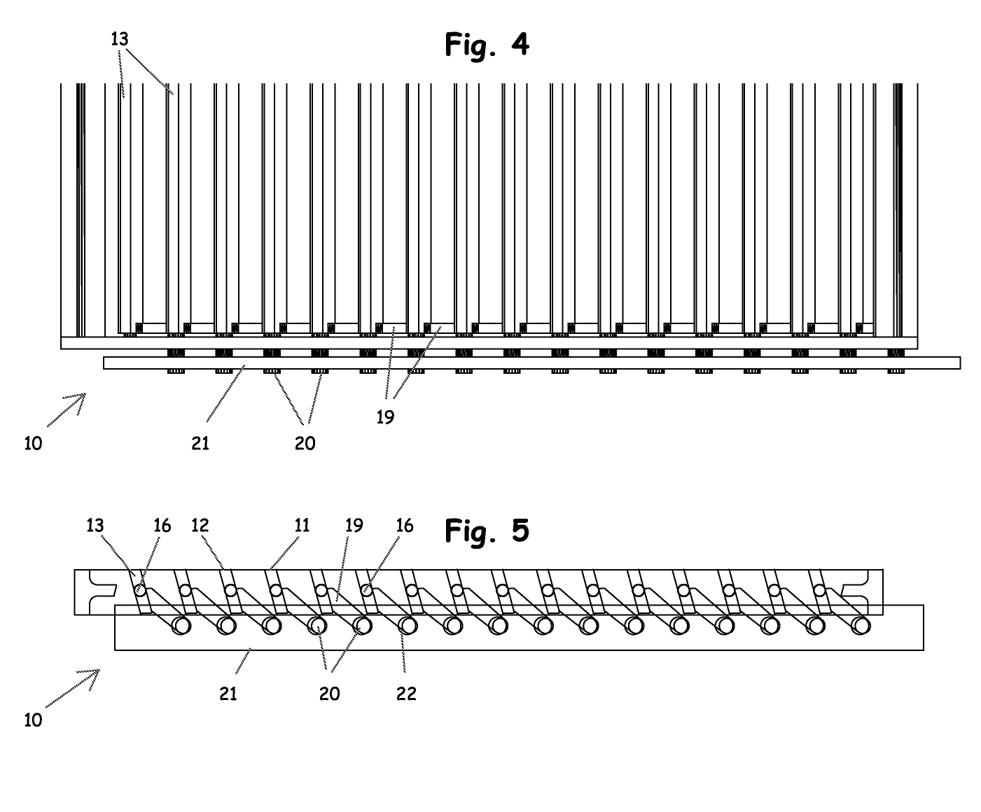

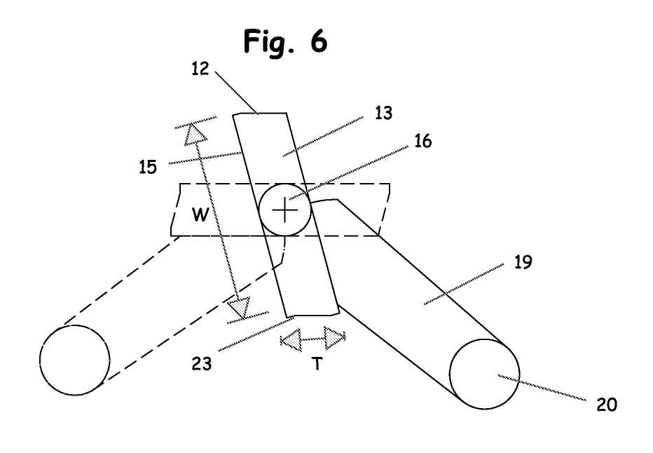

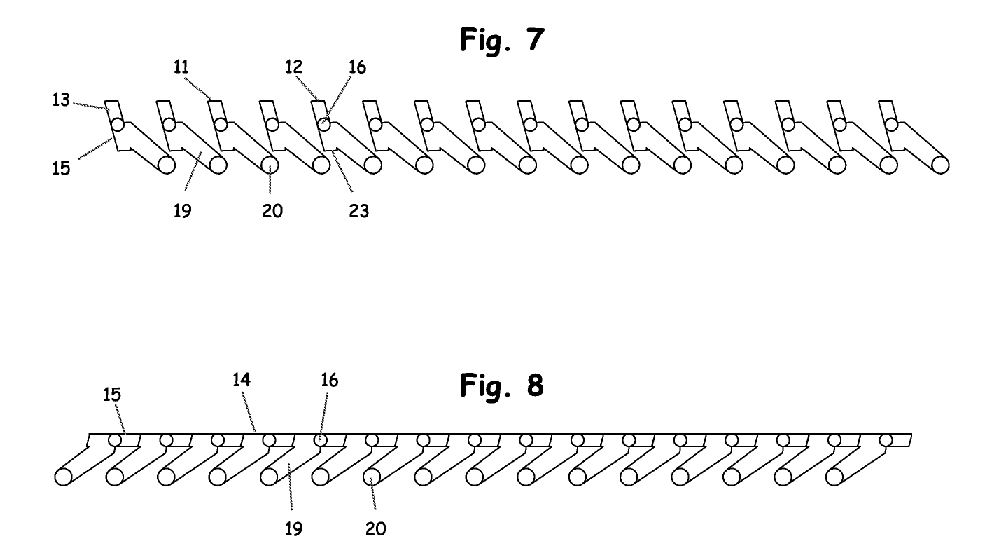

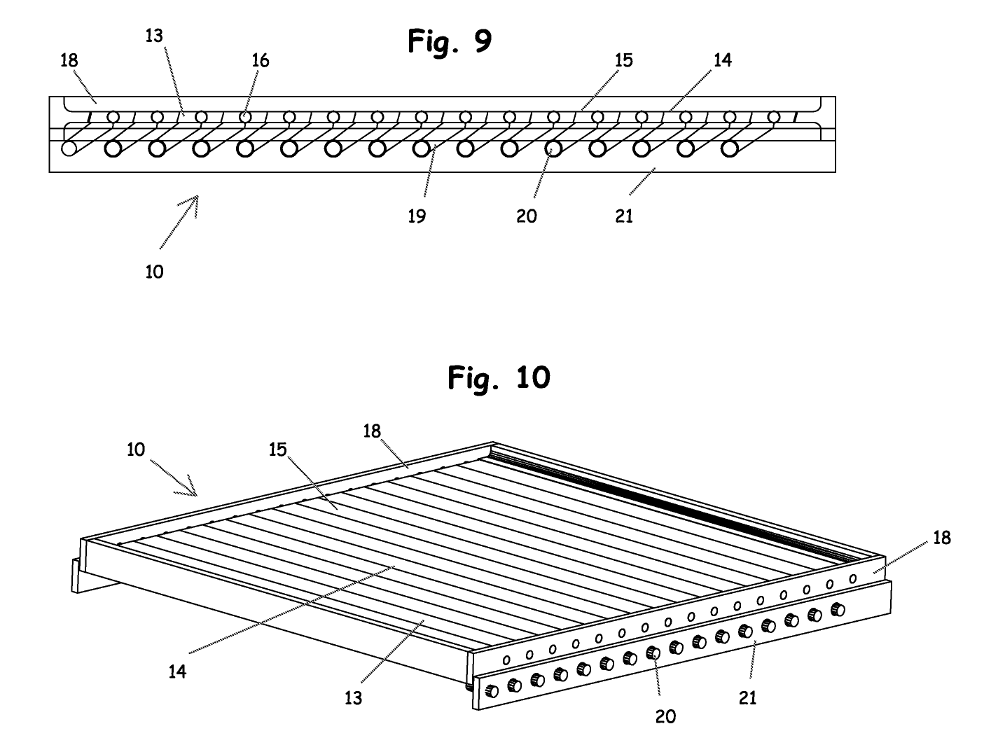

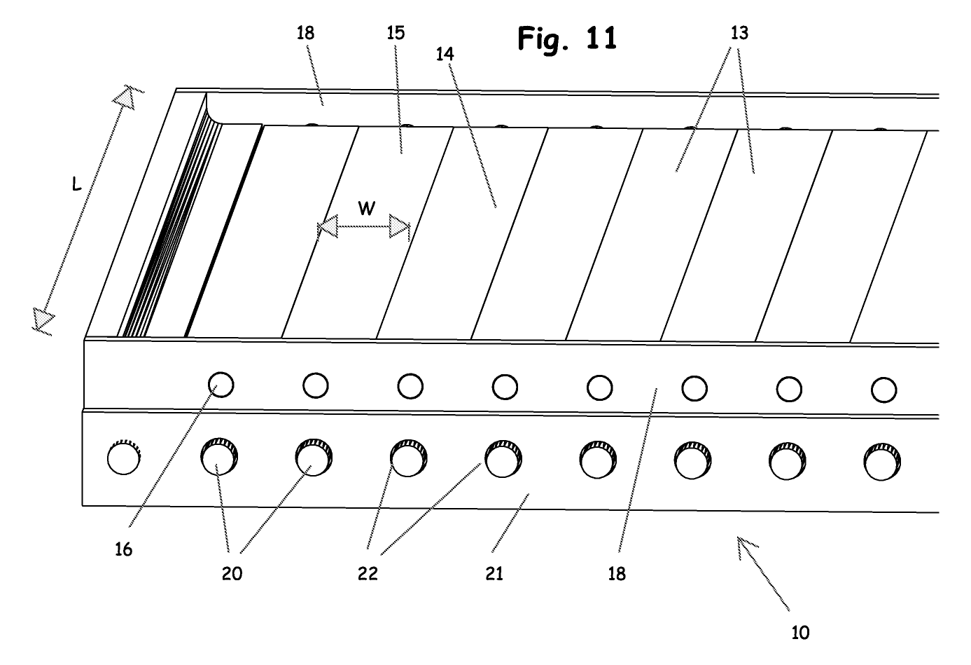

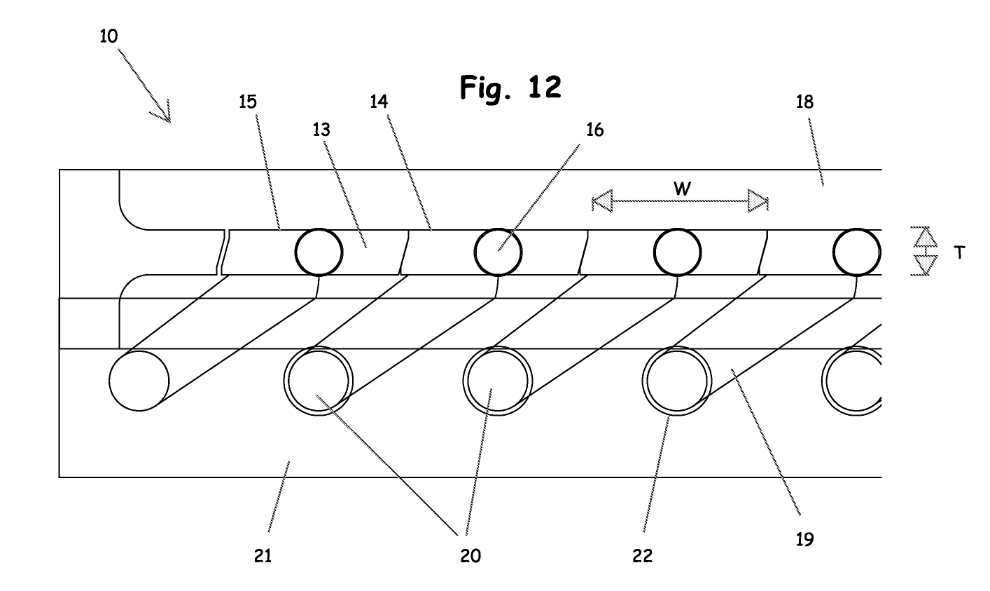

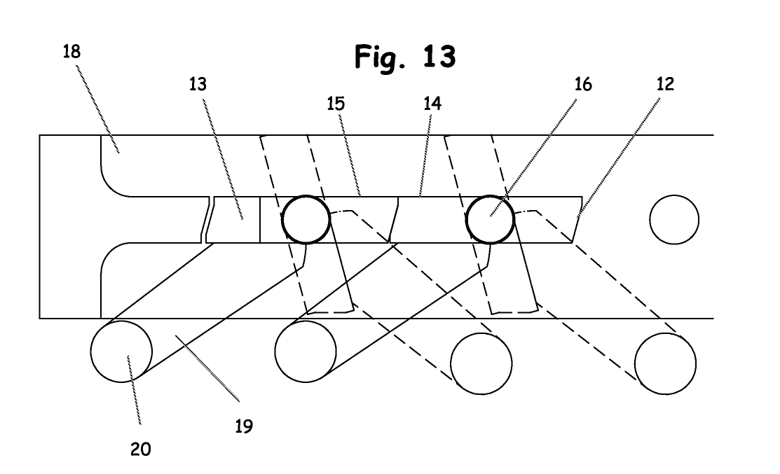

The present invention will now be described in detail with reference to FIGS. 1 to 13 of the accompanying drawings.

The convertible cooking grate 10 of the present invention provides dual cooking surfaces for use with barbecue grills and other cooking devices. In a first position (shown in FIGS. 1 to 7), a grate-like cooking surface 11 is formed by side edges 12 of a plurality of spaced apart cross bars 13 that support an item being cooked above the heat source. In a second position (shown in FIGS. 8 to 13), a substantially flat griddle-like cooking surface 14 is formed by another side of the cross bars 13 having substantially coplanar surfaces 15 that fit closely together. The griddle-like cooking surface 14 can be used to cook small items and other food stuffs that generally cannot be cooked on grills, such as pancakes and eggs.

The cooking grate 10 is formed by the cross bars 13, which comprise a plurality of substantially similar, elongate cross bars arranged in parallel relation to each other. The cross bars 13 are rotatably supported by pins 16 that extend from each end thereof and fit into corresponding holes 17 in an outer frame 18. The pins 16 allow the cross bars 13 to rotate about respective horizontal axes that generally extend in the longitudinal direction of the cross bars 13.

Pivot arms 19 are fixed to and extend from the backsides of each of the cross bars 13. The pivot arms 19 each have a pin member 20 at their free end for coupling with a mechanical linkage 21. In the illustrated embodiment, the mechanical linkage 21 is a carrier member having a series of spaced holes 22 in which the pin members 20 of the pivot arms 19 are rotatably received. The carrier member 21 can be operated to rotate the cross bars 13 together simultaneously. Other arrangements of mechanical linkages and connections can also be used to accomplish the pivoting transformation of the cross bars 13 between positions for providing a grate-like cooking surface (FIGS. 1 to 7) and positions for providing a griddle-like cooking surface (FIGS. 8 to 13).

Each of the cross bars 13 has a first portion 12 for forming the grate-like cooking surface 11, and a second portion 15 for forming the griddle-like cooking surface 14. The cross bars 13 can be rotated about the pins 16 for movement between a first position (FIGS. 1 to 7) in which the first portions 12 of the cross bars 13 are facing upwardly, and a second position (FIGS. 8 to 13) in which the second portions 15 of the cross bars 13 are facing upwardly. In the first position, the first portions 12 of the cross bars 13 face upwardly and are arranged in parallel, spaced apart relation to form the grate-like cooking surface 11. In the second position, the second portions 15 of the cross bars 13 face upwardly and are arranged in a substantially coplanar relation with each other and have side edges that fit closely together to form the griddle-like cooking surface 14.

The cross bars 13 each have a length L, a width W, and a thickness T. The first portions 12 of the cross bars 13 that provide the grate-like cooking surface 11 are edges defined by the length L and thickness T of the cross bars 13. The second portions 15 of the cross bars 13 that provide the griddle-like cooking surface 14 are substantially flat faces defined by the length L and width W of the cross bars 13. As can be seen in the drawings, the width W of each bar 13 is substantially greater than the thickness T thereof so that the pivotal movement of the cross bars 13 has the desired effect of converting the grill from a grate-like cooking surface 11 to a griddle-like cooking surface 14.

The first portions 12 of the cross bars 13 that provide the grate-like cooking surface 11 have a first surface area (L×T), and the second portions 15 of the cross bars 13 that provide the griddle-like cooking surface 14 have a second surface area (L×W). As can be seen in the drawings, the second surface area LW is substantially greater than the first surface area LT. In one embodiment, the second surface area LW is at least two times greater than the first surface area LT, and in a preferred embodiment, the second surface area LW is at least three times greater than the first surface area LT.

The side edge defining the first portion 12 of each bar 13 in the illustrated embodiment is slanted relative to the substantially flat face defining the second portion 15. In other words, the angle between a plane containing the side edge 12 and a plane containing the flat face 15 is slanted at a non-perpendicular angle. A corresponding slanted side edge 23 is provided on the opposite edge of each bar 13. The tapered side edges 12, 23 allow the cross bars 13 to abut closely together and support each other when they are moved into their second positions to provide the griddle-like cooking surface 14.

The side edges 12, 23 can also be provided with a non-flat shape. By making the first and second side edges 12, 23 correspond in shape and angle, the side edges of adjacent cross bars 13 will fit closely together and provide a substantially flat and continuous griddle-like cooking surface 14 when the cross bars 13 are moved into their second positions.

Other embodiments of the invention are contemplated in which the side edges 12, 23 are rounded or simply flat. The manufacturing costs and efficiencies, as well as the particular grill applications in which the invention is used, will determine which side edge configurations are best suited for use in the present invention.

The cooking grate assembly 10 of the present invention can be used with portable or stationary outdoor barbecue grills, and also with built-in indoor grills and commercial grade grills. The cooking grate assembly 10 is assembled together as a portable unit that can be transferred from one grill frame to another. Thus, the cooking grate assembly 10 can be conveniently moved between a conventional gas grill unit, a charcoal grill unit, and/or an open fire unit. For example, the cooking grate assembly 10 can be used in a patio gas grill frame, and still be available to take camping to be used in a charcoal or open fire frame.

The cooking grate assembly 10 can also be equipped with separate mechanical linkages, or provided as multiple units, to allow part of the grill to be set with a grate-like cooking surface 11 and another part of the grill to be set with a griddle-like cooking surface 14. This gives the user the flexibility and versatility to set the entire grill with the same type of cooking surface or to quickly adjust part of the grill to a different type of cooking surface.

While the invention has been specifically described in connection with specific embodiments thereof, it is to be understood that this is by way of illustration and not of limitation, and the scope of the appended claims should be construed as broadly as the prior art will permit.

What is claimed is:

1. A convertible cooking grate assembly for a grill, comprising:
a plurality of substantially similar elongate bars arranged in parallel relation to each other, each bar having a first portion for forming a first cooking surface and a second portion for forming a second cooking surface, said bars each being supported for rotation about respective horizontal axes for movement between a first position in which the first portions of the bars face upwardly to form said first cooking surface and a second position in which the second portions of the bars face upwardly to form said second cooking surface.

2. The convertible cooking grate assembly according to claim 1, wherein said first portions of the bars are arranged in parallel, spaced apart relation when the bars are in their first positions to form a grate-like cooking surface.

3. The convertible cooking grate assembly according to claim 2, wherein said second portions of the bars are arranged in a substantially coplanar relation with side edges that fit closely together when the bars are in their second positions to form a substantially flat griddle-like cooking surface.

4. The convertible cooking grate assembly according to claim 3, wherein said bars each have a length, a width and a thickness, said first portions being a first edge defined by the length and thickness of the bars, and said second portions being a substantially flat face defined by the length and width of the bars.

5. The convertible cooking grate assembly according to claim 4, wherein the width of each bar is substantially greater than the thickness thereof.

6. The convertible cooking grate assembly according to claim 5, wherein said first portions of the bars have a first surface area, said second portions of the bars have a second surface area, and said second surface area is substantially greater than said first surface area.

7. The convertible cooking grate assembly according to claim 6, wherein said second surface area is at least two times greater than said first surface area.

8. The convertible cooking grate assembly according to claim 6, wherein said second surface area is at least three times greater than said first surface area.

9. The convertible cooking grate assembly according to claim 5, wherein the edge defining said first portion of each bar is slanted relative to the substantially flat face defining said second portion.

10. The convertible cooking grate assembly according to claim 9, wherein said bars each have a second edge that corresponds in shape and angle to said first edge to allow the first and second edges of adjacent bars to fit closely together when the bars are in their second positions.

11. The convertible cooking grate assembly according to claim 5, wherein the edge defining said first portion of each bar is rounded.

12. The convertible cooking grate assembly according to claim 5, wherein the edge defining said first portion of each bar is perpendicular relative to the substantially flat face defining said second portion.

13. The convertible cooking grate assembly according to claim 1, further comprising a means for rotating the bars between their first and second positions.

14. The convertible cooking grate assembly according to claim 13, wherein said means for rotating comprises a mechanical linkage to rotate the bars together simultaneously.

15. The convertible cooking grate assembly according to claim 1, wherein the elongate bars are assembled together as a portable unit that can be transferred from one grill frame to another.

16. A convertible cooking grate assembly for a grill, comprising:
an outer frame;
a plurality of substantially similar elongate bars having pins that extend from each end thereof, said pins being fit into corresponding holes in said outer frame to allow said bars to rotate relative to said outer frame, said bars being arranged in parallel relation to each other;
each of said bars having a first portion for forming a first cooking surface and a second portion for forming a second cooking surface, said bars each being supported for rotation relative to said outer frame about respective horizontal axes for movement between a first position in which the first portions of the bars face upwardly to form said first cooking surface and a second position in which the second portions of the bars face upwardly to form said second cooking surface;
said first portions of the bars are arranged in parallel, spaced apart relation when the bars are in their first positions to form a grate-like cooking surface; and
said second portions of the bars are arranged in a substantially coplanar relation with side edges that fit closely together when the bars are in their second positions to form a substantially flat griddle-like cooking surface.

17. The convertible cooking grate assembly according to claim 16, wherein said bars each have a length, a width and a thickness, said first portions being a first edge defined by the length and thickness of the bars, and said second portions being a substantially flat face defined by the length and width of the bars.

18. The convertible cooking grate assembly according to claim 17, wherein the width of each bar is substantially greater than the thickness thereof.

19. The convertible cooking grate assembly according to claim 16, wherein said first portions of the bars have a first surface area, said second portions of the bars have a second surface area, and said second surface area is at least two times greater than said first surface area.

20. The convertible cooking grate assembly according to claim 1, further comprising a mechanical linkage for rotating the bars together simultaneously between their first and second positions.
